(19) United States
(12) Patent Application Publication
(10) Pub. No.: US 2023/0268624 A1
(43) Pub. Date: Aug. 24, 2023

(54) BATTERY WELD PLATES

(71) Applicant: TECHTRONIC CORDLESS GP, Anderson, SC (US)

(72) Inventors: Dan GENG, Gongguan City (CN); Aditya SUBRAMANIAN, Hong Kong (CN); Denis Gaston FAUTEUX, Hong Kong (CN); Jin Wei LI, Dongguan City (CN)

(21) Appl. No.: 18/004,853

(22) PCT Filed: Jul. 29, 2020
(86) PCT No.: PCT/CN2020/105499

§ 371 Date: Jan. 9, 2023

(51) Int. Cl. H01M 50/536; H01M 10/04; H01M 50/533; H01M 50/77

(52) U.S. Cl. CPC H01M 50/536; H01M 10/0431; H01M 50/533; H01M 50/77

(57) ABSTRACT

Disclosed is a relieved weld plate for affixing to a battery core to provide an electrical connection between the battery core and a terminal of a battery. The relieved weld plate includes a conductive face configured for affixing to an electrode of the battery core. The relieved weld plate further includes one or more pathways disposed in the conductive face. The one or more pathways are configured to facilitate at least one of an ingress of a first material into the battery core or an egress of a second material out of the battery core.

### CROSS-REFERENCE TO RELATED APPLICATIONS

The present application is related to U.S. Patent Application Number U.S. patent application Ser. No. 16/739,823 entitled “Batteries Providing High Power and High Energy Density,” filed on Jan. 10, 2020, the disclosure of which is hereby incorporated herein in its entirety by reference.

### TECHNICAL FIELD

The present invention relates generally to batteries and, more particularly, to weld plates, such as used with respect to a cathode and/or an anode of a battery.

### BACKGROUND OF THE INVENTION

The use of various forms of batteries has become nearly ubiquitous. As more portable or cordless devices, such as power tools (e.g., drills, saws, grass trimmers, blowers, sanders, etc.), small appliances (e.g., mixers, blenders, coffee grinders, etc.), communications devices (e.g., smartphones, personal digital assistants, etc.), and office equipment (e.g., computers, tablets, printers, etc.), are in widespread use, the use of battery technologies of varying chemistry and configuration is commonplace.

A common battery configuration is a cylindrical jellyroll arrangement. In this battery configuration, a separator, such as a membrane or other medium allowing the passage of ions, is interspersed between a cathode and an anode. The cathode, the separator, and the anode are rolled cylindrically such that the cathode, the separator, and the anode resemble the concentric spirals of a jellyroll. The cylindrically rolled cathode, separator, and anode are placed longitudinally within a battery housing, usually with electrical terminals disposed at either end, to provide the completed battery structure.

### BRIEF SUMMARY OF THE INVENTION

The present invention is directed to systems and methods which provide relieved weld plates having one or more pathways configured to permit ingress and/or egress of material (e.g., electrolyte, gasses generated by the battery, etc.) with respect to the battery core. For example, the battery may have a jellyroll configuration in which a cathode, separator, and an anode form a battery core disposed longitudinally within a housing of the battery. The one or more pathways of a relieved weld plate (e.g., a cathode relieved weld plate affixed to a cathode electrode of the battery and/or an anode relieved weld plate affixed to an anode electrode of the battery) of embodiments of the present invention may, for example, facilitate the initial introduction (and/or reintroduction) of electrolyte into the battery core. Additionally or alternatively, the one or more pathways of a relieved weld plate of embodiments of the present invention may facilitate passage of gases created in the operation or failure of the battery.

Relieved weld plates of some embodiments of the invention are configured to contact a large surface area of a corresponding electrode (e.g., an electrode of a cathode or an anode of a jellyroll battery) such as to reduce an electrical resistance of the battery. The battery may have a jellyroll configuration in which the cathode and the anode are offset from one another such that an offset portion of the cathode extends outward from a first longitudinal end of the jellyroll and such that an offset portion of the anode extends outward from a second longitudinal end of the jellyroll. The offset portion of the cathode may be referred to as a cathode electrode, and the offset portion of the anode may be referred to as an anode electrode. Further, the cathode, the anode, and the separator may be wrapped around a mandrel such that the cathode, the anode, and the separator form concentric spirals extending radially outward from the mandrel. Relieved weld plates provided according to concepts of the invention may be configured to facilitate a relatively large contact interface between the relieved weld plate and a respective electrode of such a jellyroll configuration. For example, a pathway configuration in which pathways are formed as a relief area disposed radially inboard within a conductive face of the relieved weld plate (referred to herein as full pathways), such as to mitigate or minimize an amount of relieved weld plate conductive face material relieved toward the outer edge of the conductive face (e.g., an area corresponding to larger concentric spirals of the jellyroll), may be implemented to provide a relatively large contact interface between the relieved weld plate and one or more inner concentric spirals of the electrode. Additionally or alternatively, a pathway configuration in which pathways are formed as a relief area defining interstitial space between a battery housing and regions of a conductive face of the relieved weld plate (referred to herein as interstitial pathways), such as to provide radially extending members traversing a large extent of the battery core (e.g., an area corresponding to a large or optimized number of the concentric spirals of the jellyroll), may be implemented to provide a relatively large contact interface between the relieved weld plate and the concentric spirals of the electrode.

In operation according to embodiments, materials, such as electrolyte, can be placed into a battery through pathways (e.g., full pathways and/or interstitial pathways) positioned within the conductive face of a relieved weld plate (e.g., a cathode relieved weld plate and/or an anode relieved weld plate). As another example, if the battery were to catastrophically fail (e.g., rapidly outgas), gases produced by the battery chemistry may exit through the pathways of the relieved weld plate to prevent the battery from exploding.

Topologies of a relieved weld plate, in which the conductive face includes one or more pathways, may be configured to increase a surface area of the conductive region of the cathode weld plate in contact with an electrode of the battery core (e.g., a cathode electrode or an anode electrode), such as to decrease an electrical resistance of the battery. Additionally or alternatively, topologies of a relieved weld plate, in which the conductive face includes one or more pathways, may be configured to facilitate the ingress and/or egress of material (e.g., electrolyte, gasses generated by the battery, etc.). For example, topologies of a relieved weld plate may include pathways, positioned within the conductive face of a relieved weld plate, having a sufficient area to reduce an amount of time to fill the battery housing with materials (e.g., electrolyte) and to permit rapid egress of materials out of the battery housing (e.g., gases produced by electrolytic chemical reactions occurring within the battery). In embodiments, topologies of relieved weld plates (e.g., cathode relieved weld plate configurations) including full pathways may provide surface areas of between 180 mm² to 193 mm² of conductive face in contact with an electrode of a battery and pathways having areas of between 49 mm² and 62 mm². As another example, topologies of relieved weld plates (e.g., anode relieved weld plate configurations) including full pathways may provide surface areas of between 193 mm² and 205 mm² of conductive face in contact with an electrode of a battery and pathways having areas of between 49 mm² and 62 mm². In embodiments, topologies of relieved weld plates (e.g., cathode relieved weld plate configurations) including interstitial pathways may provide surface areas of between 111 mm² to 147 mm² of conductive face in contact with an electrode of a battery and pathways having areas of between 97 mm² and 131 mm². As another example, topologies of relieved weld plates (e.g., anode relieved weld plate configurations) including interstitial pathways may provide surface areas of between 124 mm² and 157 mm² of conductive face in contact with an electrode of a battery and pathways having areas of between 97 mm² and 131 mm².

Relieved weld plates of embodiments may thus include topologies having the advantage of optimizing a surface area of the conductive face of the relieved weld palate in contact with a corresponding electrode of a battery, while including pathways of sufficient area to permit the rapid ingress of materials (e.g., electrolyte) into the battery housing and/or the rapid egress of materials (e.g., gases generated by the battery chemistry) out of the battery core. In this manner, an electrical resistance of the battery may be reduced due to the large contact area between conductive regions of the relieved weld plates and the electrodes, while providing sufficient area for the ingress of materials into and/or the egress of materials out of the battery core. Further, relieved weld plates of embodiments may have topologies that are easily manufactured through metal stamping processes known in the art, through three dimensional printing methodologies, through laser sintering, or through other methodologies. Moreover, the topologies of relieved weld plates of some embodiments may be easily welded onto corresponding electrodes of a battery.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not indented as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a relieved weld plate (i.e., a cathode relieved weld plate configuration and an anode relieved weld plate configuration) having interstitial pathways and positioned within a battery according to embodiments of the present invention;

FIG. 2 shows a first particular relieved weld plate topology according to embodiments of the present invention;

FIG. 3 shows a second particular relieved weld plate topology according to embodiments of the present invention;

FIG. 4 shows a third particular relieved weld plate topology according to embodiments of the present invention;

FIG. 5 shows a fourth particular relieved weld plate topology according to embodiments of the present invention;

FIG. 6 shows a fifth particular relieved weld plate topology according to embodiments of the present invention;

FIG. 7 shows a sixth particular relieved weld plate topology according to embodiments of the present invention;

FIG. 8 shows a seventh particular relieved weld plate topology according to embodiments of the present invention;

FIG. 9 shows an eighth particular relieved weld plate topology according to embodiments of the present invention;

FIG. 10 shows a table with comparative parameters of the disclosed topologies according to embodiments of the present invention; and

FIG. 11 is a flowchart corresponding to a method for affixing a relieved weld plate onto one or more concentric spirals (e.g., areas) an electrode.

### DETAILED DESCRIPTION

Disclosed are relieved weld plate topologies configured to include one or more pathways of sufficiently large area to permit rapid ingress of material into a battery core and/or to permit the rapid egress of material out of the battery core. Relieved weld plates of embodiments of the present invention may, for example, comprise various configurations of pathways configured to facilitate ingress and/or egress of materials into or out of the battery core in accordance with concepts herein. The relieved weld plate topologies of embodiments are further configured to provide a relatively large contact surface area between a conductive face of the relieved weld plate and one or more concentric spirals (e.g., areas) corresponding to an electrode of the battery core. Accordingly, the disclosed relieved weld plate topologies may reduce an electrical resistance of the battery while enhancing one or more aspects of a battery with respect to material ingress and/or egress (e.g., improved manufacturing and/or refurbishment techniques through improved ingress of electrolyte, improved reliability and/or safety through improved egress of gasses, etc.).

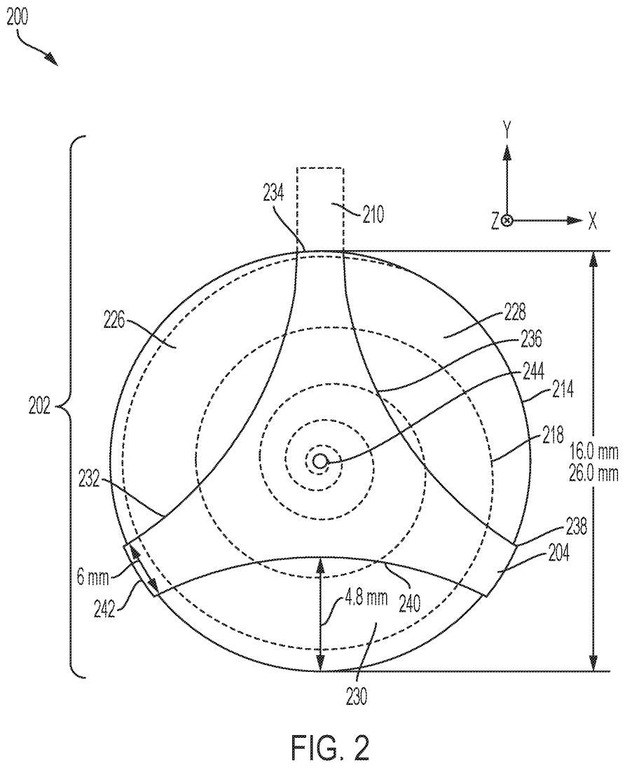

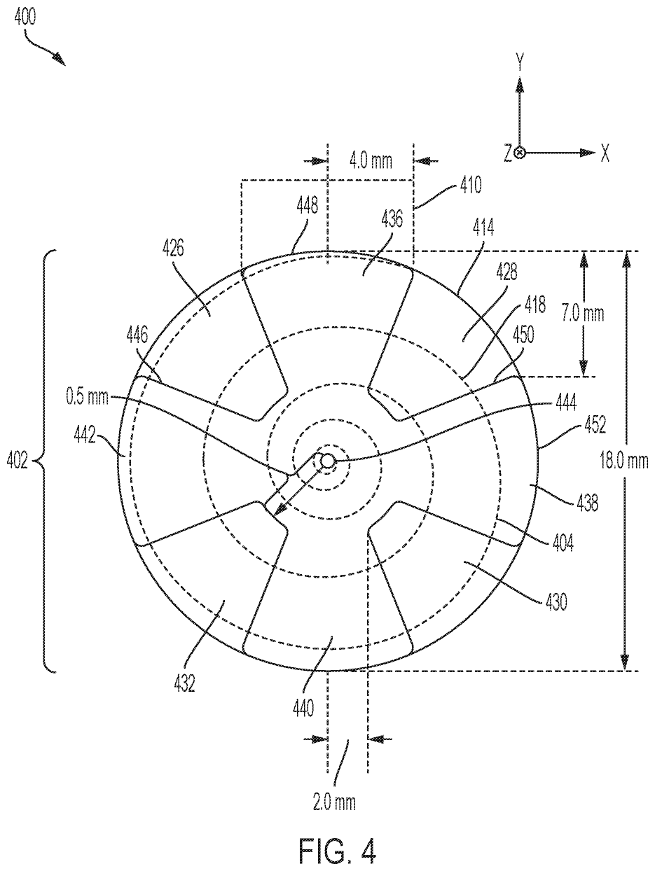

In accordance with some embodiments of the invention, one or more interstitial pathway configurations, wherein pathways are formed as a relief area defining interstitial space between a battery housing and regions of a conductive face of the relieved weld plate, may be implemented. Examples of relieved weld plate topologies including interstitial pathways are described more fully below with reference to FIGS. 2-6. In an example topology, such as the topology described in FIG. 4, a surface area of the conductive face of the relieved weld plate (e.g., a cathode relieved weld plate) in contact with concentric spirals of an electrode (e.g., a cathode electrode) may be between approximately 133 mm² and 161 mm². In the example topology, a surface area of the conductive face of the relieved weld plate (e.g., an anode relieved weld plate) in contact with concentric spirals of an electrode (e.g., an anode electrode) may be between approximately 141 mm² and 172 mm². In the foregoing example, a cumulative area of the interstitial pathways may be between approximately 87 mm² and 107 mm².

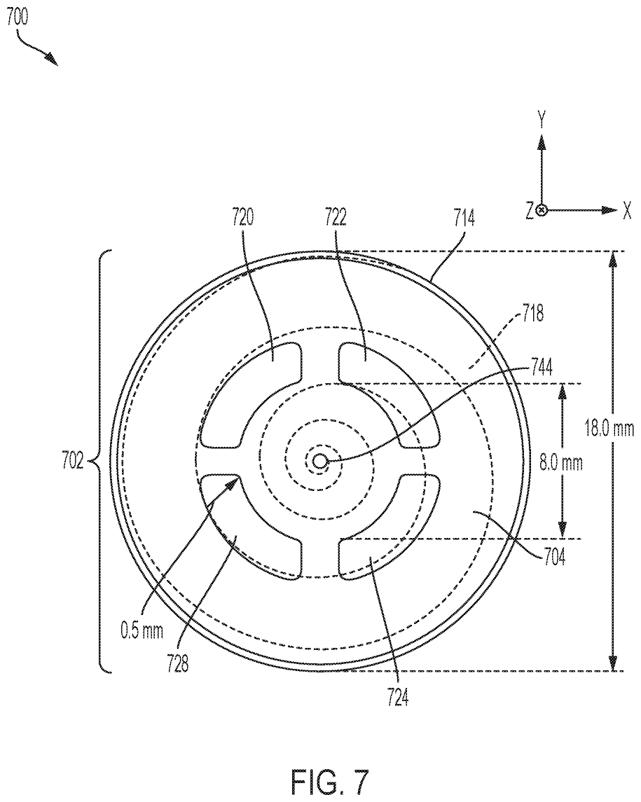

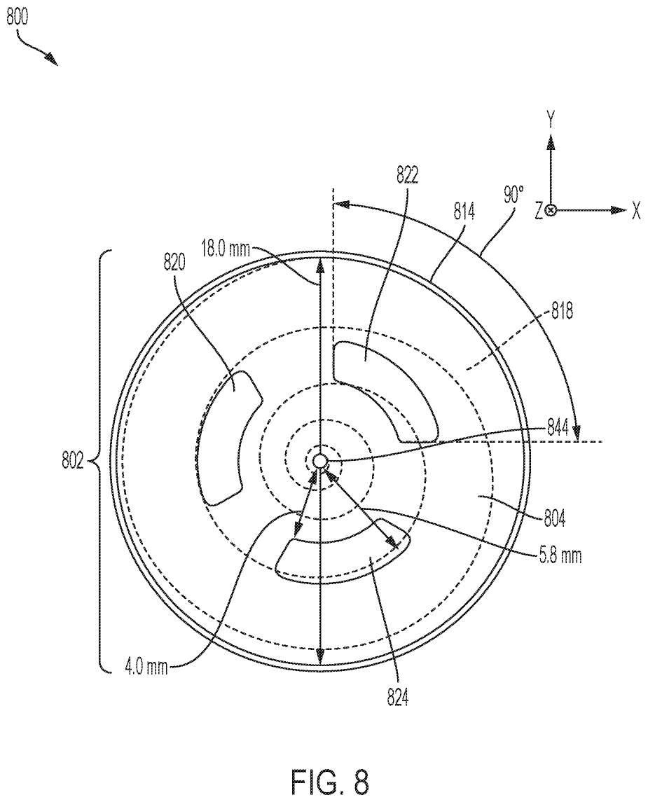

In some embodiments of the invention, one or more full pathway configurations, wherein pathways are formed as a relief area disposed radially inboard within a conductive face of the relieved weld plate, may be implemented. Examples of relieved weld plate topologies including full pathways are described more fully below with reference to FIGS. 7-9. In an example topology, such as the topology of FIG. 8, a surface area of the conductive face of the relieved weld plate (e.g., a cathode relieved weld plate) in contact with one or more concentric spirals corresponding to an electrode (e.g., a cathode electrode) may be between approximately 173 mm² and 211 mm² and a surface area of the conductive face of the relieved weld plate (e.g., an anode relieved weld plate) in contact with an electrode (e.g., an anode electrode) may be approximately 185 mm² and 225 mm². In the foregoing example, an area of the full pathways may be between approximately 45 mm² and 55 mm².

The pathways (e.g., interstitial pathways, full pathways, etc.) may confer several advantages. For example, the pathways may provide access to inner concentric spirals (e.g., inner areas) of the battery core to facilitate affixing of the conductive face of the relieved weld plate to one or more concentric spirals (e.g., areas) corresponding to the electrode. To elaborate, inner concentric spirals (e.g., inner areas) corresponding to the electrode may be exposed to a laser, an ultrasonic welder, or other welding devices through the pathways such that one or more of the inner concentric spirals (e.g., inner areas), in addition to one or more of the outer concentric spirals (e.g., outer areas), of the electrode may be welded onto the conductive face of the relieved weld plate. Thus, the pathways may render affixing of the relieved weld plate to concentric spirals (e.g., areas) of an electrode simpler and less cumbersome. In this way, the pathways enhance a battery manufacturing process.

Additionally, by affixing at least some of the inner concentric spirals in addition to one or more outer concentric spirals of the electrode to the conductive face of the relieved weld plate, an electrical resistance of the relieved weld plate may be reduced, because a larger surface area of the electrode may be electrically contacted to the relieved weld plate. By reducing an electrical resistance of the relieved weld plate, a total electrical resistance of the battery may be reduced. Thus, the pathways enhance an overall operation of the battery.

Further, the pathways may facilitate the introduction or reintroduction of materials, such as electrolyte, into the battery core. In particular, the electrolyte may be a viscous material, and the pathways may facilitate introduction of the viscous electrolyte into the battery core. In the case of refurbishment of an older battery, the pathways may facilitate reintroduction of viscous electrolyte into the battery core, thereby enhancing a battery recycling process (e.g., by making the recycling process more efficient). By facilitating introduction or reintroduction of materials into the battery core, the pathways enhance a battery manufacturing process.

Additionally, the pathways may render batteries safer. To illustrate, the pathways may permit the egress of material out of the battery core. For instance, during operation of the battery, reactive gases may be produced through electrolytic chemical reactions. These gases may escape through the pathways, thereby rendering operation of the batteries safer.

Pathways (e.g., interstitial pathways, full pathways, etc.) may be formed in various ways. For example, a piece of material may be mechanically stamped out of a sheet of conductive material (e.g., aluminum, copper, nickel, stainless steel, etc.) in a pattern corresponding to one of the topologies of FIGS. 2-9. The piece of material may be positioned within a battery to form a relief area defining interstitial space between a battery housing and regions of the conductive face (i.e., the conductive material) of the relieved weld plate thereby forming interstitial pathways. As another example, full pathways may be formed by etching a piece of conductive material (e.g., via laser, chemical etch, or pathway mechanical puncture) to form pathways disposed radially inboard within the face of the conductive material. As another example, a relieved weld plate may be printed using three dimensional metal printing technology. The pathways may correspond to non-printed areas (i.e., areas in which conductive material is not deposited).

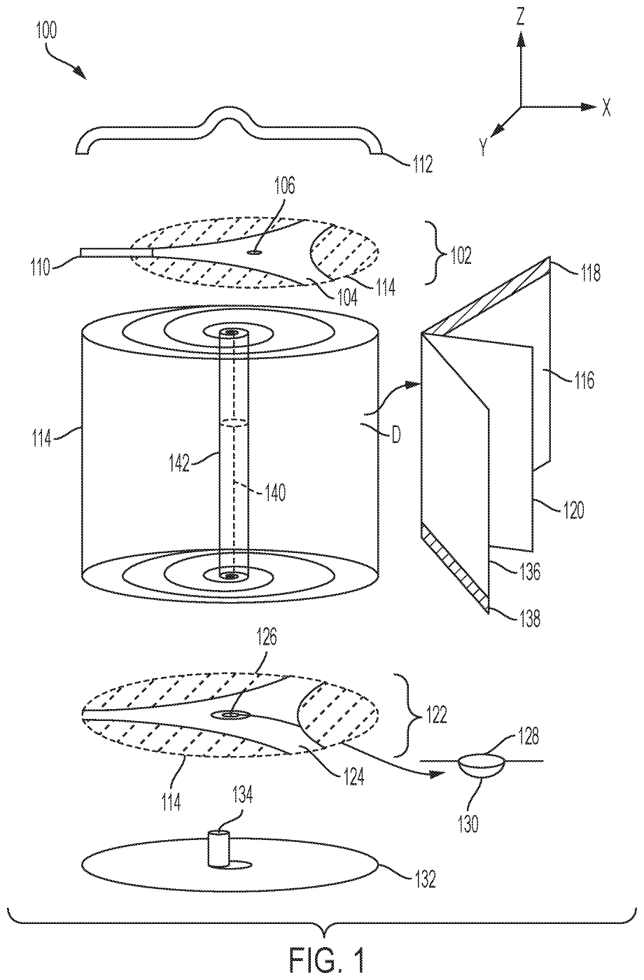

FIG. 1 depicts battery 100 from the perspective of the coordinate system shown in FIG. 1. In the example of FIG. 1, battery 100 includes separator 120 interspersed between cathode 116 and anode 136. Separator 120, cathode 116, and anode 136 may be wrapped cylindrically in a jellyroll configuration to form a battery core, and may be placed longitudinally in battery housing 114 to form battery 100. In the example of FIG. 1, separator 120, cathode 116, and anode 136 may be wrapped cylindrically around mandrel 142, and pin 140 may be disposed within mandrel 142. In an embodiment of the invention, mandrel 142 may be a cylindrical hollow sheath comprised of an electrically insulating material such as plastic. As explained more fully below, pin 140 may extend longitudinally from relieved anode weld plate through to relieved cathode weld plate 102, and a portion of pin 140 may protrude longitudinally outward through hollow region 106 to provide a terminal (e.g., a negative terminal) on battery cap 112. In the illustrated embodiment, cathode electrode 118 extends in a first longitudinal direction from the battery core, and anode electrode 138 extends in a second longitudinal direction (i.e., opposite to the first longitudinal direction) from the battery core. As shown in FIG. 1, cathode electrode 118 and anode electrode 138 are concentrically wound spirals extending radially outward from mandrel 142 defining a center of battery 100.

Weld plates may be utilized to provide a conductive interface between the battery core of battery 100 and respective battery terminals. Accordingly, battery 100 of the illustrated embodiment is shown as including cathode relieved weld plate 102 and anode relieved weld plate 122. Cathode relieved weld plate 102 provides a conductive surface configured to interface with cathode electrode 118 and is further configured for electrical connection to terminal cap 112 of the battery (e.g., via tab 110 of cathode relieved weld plate 102). Anode relieved weld plate 122 provides a conductive surface configured to interface with anode electrode 138 and is further configured for electrical connection to terminal base 132 of the battery (e.g., via weld detent 130 and base contact 134). It can be appreciated from the illustration of FIG. 1 that weld plates, once affixed to the battery core, can present an obstacle with respect to the ingress of material (e.g., electrolyte) into the battery core and egress of material (e.g., gasses) out of the battery core. Accordingly, weld plates of battery 100 shown in FIG. 1 are configured as relieved weld plates having relief areas defining one or more pathways therethrough. As described in further detail below, pathways of the relieved weld plates of embodiments are configured (e.g., oriented, sized, disposed, shaped, etc.) to facilitate ingress and/or egress of materials and to facilitate a low impedance battery implementation.

In the example of FIG. 1, cathode relieved weld plate 102 includes first conductive face 104. First conductive face 104 may be comprised of a conductive material, such as aluminum, nickel, and/or stainless steel. First conductive face 104 is configured to be affixed onto cathode electrode 118. For instance, first conductive face 104 may be affixed onto one or more concentric spirals (e.g., areas) of cathode electrode 118 using known welding techniques (e.g., laser welding, ultrasonic welding, etc.). In the embodiment depicted in FIG. 1, cathode relieved weld plate 102 includes a second conductive face opposite of first conductive face 104. At least a portion of the second conductive face may be coated with a dielectric material, such as an electrically insulative polymer. The dielectric coating may electrically isolate a portion of the second surface from other components of battery 100, such as terminal cap 112.

Although configured according to the topology described in FIG. 2, cathode relieved weld plate 102 may be configured according to various topologies, such as any of the topologies described in FIGS. 2-9. Thus, cathode relieved weld plate 102 may include interstitial pathways, full pathways, or a combination thereof, depending on the topology of the cathode relieved weld plate. Regardless of the topology, pathways (depicted using hatching) may be configured for ingress of materials, such as electrolyte, into the battery core and/or for egress of materials, such as gases, out of the battery core.

Additionally, in the example of FIG. 1 cathode relieved weld plate 102 includes tab 110. Tab 110 may be formed from the material of the cathode relieved weld plate 102. Tab 110 may be bent towards the second surface (as depicted in FIG. 1) so that a portion of tab 110 may electrically contact terminal cap 112. In implementations, tab 110 may be welded onto terminal cap 112.

Additionally or alternatively, in the example of FIG. 1, cathode relieved weld plate 102 includes hollow region 106 positioned within first conductive face 104. Hollow region 106 may be configured to receive pin 140, extending vertically from base 132 of battery 100. Pin 130 may be configured to electrically contact base 132 of battery 100 to terminal cap 112. In an embodiment of the invention, terminal cap 112 may include a positive terminal electrically contacted to cathode relieved weld plate 102, and terminal cap 112 may include a negative terminal electrically contacted to anode relieved weld plate 122 via pin 140.

In the example of FIG. 1, anode relieved weld plate 122 includes third conductive face 124. Third conductive face 124 may be comprised of a conductive material, such as nickel, nickel plated copper, and/or an alloy consisting of the two. Third conductive face 124 is configured to be affixed onto one or more concentric spirals (e.g., areas) of anode electrode 138. For instance, third conductive face 124 may be configured to be affixed onto one or more concentric spirals of anode electrode 138 using known welding techniques (e.g., laser welding, ultrasonic welding, etc.). In the embodiment depicted in FIG. 1, anode relieved weld plate 122 includes a fourth conductive face opposite of third conductive face 124. In an embodiment, at least a portion of the fourth conductive face may be coated with a dielectric material, such as a dielectric polymer.

As depicted in the example of FIG. 1, anode relieved weld plate 122 includes contact region 126. Contact region 126 includes weld detent 130 and indented region 128. Weld detent 130 is configured to be affixed onto base contact 134. For instance, weld detent 130 may be welded onto base contact 134 using known welding techniques (e.g., laser welding, etc.). Indented region 128 is configured to receive pin 140 that extends vertically upwards from weld detent 130 through hollow region 106 of cathode relieved weld plate 102.

Although depicted as being configured according to the topology described in FIG. 2, anode relieved weld plate 122 may be configured according to any of the topologies described in FIGS. 2-9. Thus, anode relieved weld plate 122 may include interstitial pathways and/or full pathways, depending on the topology of the anode relieved weld plate 122. Regardless of the topology, pathways (e.g., interstitial pathways or full pathways) may be configured for ingress of materials, such as electrolyte, into the battery core and/or for egress of materials, such as gases, out of the battery core.

Further, in embodiments of the invention, a cathode relieved weld plate of a battery may be configured according to a first topology (e.g., one of the topologies of FIGS. 2-9), while an anode relieved weld plate of the battery may be configured to a second topology distinct from the first topology (i.e., another of the topologies of FIGS. 2-9). For example, a cathode relieved weld plate may be configured according to the topology of FIG. 2 (e.g., having interstitial pathways), while an anode relieved weld plate may be configured according to the topology of FIG. 8 (e.g., having full pathways). Additionally, a topology having interstitial pathways also could have full pathways. For instance, portions of a conductive face of a relieved well plate configured according to a topology of FIGS. 2-6 may be relieved to include full pathways. To illustrate and referring to FIG. 2, first conductive face 204 may include relief areas corresponding to full pathways similar to the full pathways (first pathway 722, second pathway 724, etc.) of FIG. 7.

FIGS. 2-6 depict topologies of relieved weld plates (e.g., cathode relieved weld plates, anode relieved weld plates) in which interstitial pathways are formed. The topologies of FIGS. 2-6 achieve different tradeoffs between an area of the conductive face of the relieved weld plates and an area of the interstitial pathways, respectively. For example, in some topologies, the surface area of the conductive face is larger than in other topologies resulting in the cumulative area of the interstitial pathways to be smaller than in other topologies. In embodiments, a percentage of a total surface area of a relieved weld plate constituting interstitial vias and having one of the topologies of FIGS. 2-6 may be between 30%-55%.

Further, as depicted in FIGS. 2-6, the interstitial pathways may render one or more inner concentric spirals of the electrode (e.g., the cathode electrode and/or the anode electrode) accessible to facilitate affixing of a conductive face (e.g., first conductive face 104, second conductive face 124) of the relieved weld plate to the one more inner concentric spirals of the electrode. In this manner, in addition to affixing the conductive face of the relieved weld plate to one or more outer concentric spirals of the electrode, the conductive face of the relieved weld plate also may be affixed to one or more of the inner concentric spirals of the electrode. Thus, a relatively large surface area of the conductive face may electrically contact the electrode thereby reducing an electrical resistance of the relieved weld plate. By reducing an electrical resistance of the relieved weld plate, an electrical resistance of the battery may be reduced.

In cathode relieved weld plate configurations of the topologies described in FIGS. 2-6, the relieved weld plate may include a tab having similar features and functionality as tab 110 of FIG. 1. Further, cathode relieved weld plate configurations of the relieved weld plates described in FIGS. 2-6 may include a hollow region (e.g., hollow region 106 of FIG. 1) positioned substantially at a center of the relieved weld plate. A pin (e.g., pin 140 of FIG. 1) enclosed in a mandrel (e.g., mandrel 142 of FIG. 1) positioned substantially at a center of a battery (e.g., as depicted in FIG. 1) may extend longitudinally from a base of the battery and may protrude outwards through the hollow region to electrically contact the anode (e.g., anode 136) of the battery to a terminal positioned on a cap of the battery.

In anode relieved weld plate configurations of the topologies described in FIGS. 2-6, the relieved weld plate may include a contact region (e.g., contact region 126 of FIG. 1). The contact region may have substantially the same features and functionality as contact region 126 of FIG. 1. The contact region may be positioned substantially at a center of the relieved weld plate to align with the mandrel (e.g., mandrel of FIG. 1), the pin (e.g., pin 140 of FIG. 1), and the hollow region of the cathode relieved weld plate so that the pin can extend longitudinally from the base of the battery to the terminal cap (e.g., terminal cap 112) of the battery through a hollow region (e.g. hollow region 106 of FIG. 1) of the cathode relieved weld plate.

In embodiments, a thickness (i.e., in a z dimension as shown in coordinate axes of FIGS. 2-6) of a relieved weld plate that corresponds to a cathode relieved weld plate may be between 0.25 mm to 1.5 mm. In embodiments, a thickness (i.e., in a z dimension as shown in coordinate axes of FIGS. 2-6) of a relieved weld plate that corresponds to an anode relieved weld plate may be between 0.15 mm to 1 mm. The foregoing thicknesses facilitate affixing the relieved weld plates to the cathode electrode or to the anode electrode, respectively. For instance, if a relieved weld plate has a smaller thickness than the foregoing thicknesses, a welding operation would be too difficult, because energy generated by the welding apparatus may vaporize portions of the relieved weld plate. Conversely, if a relieved weld plate has a thickness greater than the foregoing thicknesses, excessive energy may be required to affix the relieved weld plate onto the electrode, thereby rendering a welding operation inefficient.

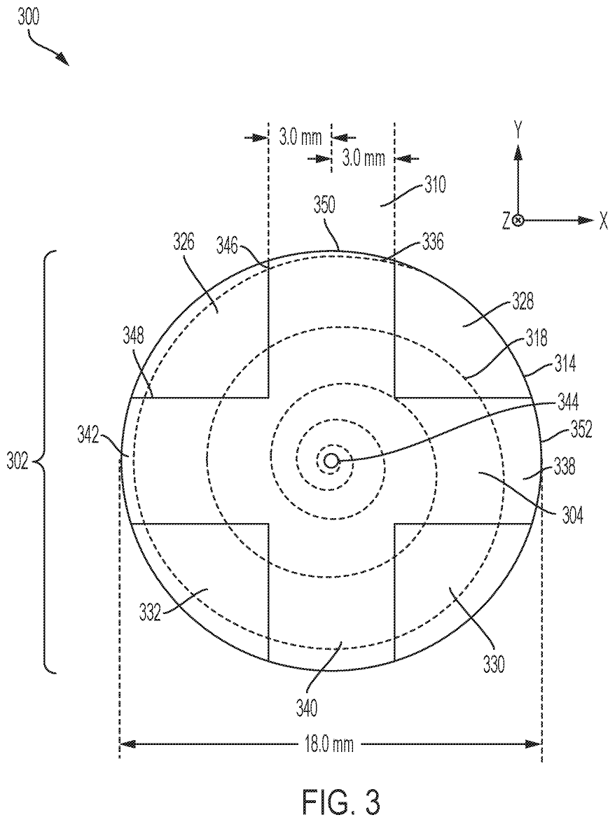

Any dimensions provided in FIGS. 2-6 are exemplary. Relieved weld plates depicted in FIGS. 2-6 having other dimensions (i.e., dimensions other than those set forth in FIGS. 2-6) may be fabricated according to embodiments of the invention. For instance, although FIG. 3 depicts a dimension of relieved weld plate 302 as having a distance of 18 mm, the dimension may have a distance less than or greater than 18 mm.

FIG. 2 depicts relieved weld plate 202 (e.g., a cathode relieved weld plate, an anode relieved weld plate, etc.) configured according to first topology 200 shown from a perspective of the coordinate system of FIG. 2. As depicted in FIG. 2, relieved weld plate 202 has the dimensions set forth in FIG. 2; however, these dimensions are exemplary. A relieved weld plate configured according to the first topology 200 may have dimensions different from those set forth in FIG. 2.

In the example of FIG. 2, relieved weld plate 202 includes first conductive face 204. First conductive face 204 is disposed on a side of relieved weld plate 202 that faces the battery core for electrically connecting to the battery core by contacting at least a portion of electrode 218 (e.g., cathode electrode, anode electrode). Electrode 218 is positioned longitudinally within battery housing 214 and is a part of a battery core (e.g., comprising a cathode, anode, and separator) of a battery. Concentric spirals (e.g., areas) of electrode 218 extend radially outward from a center of the battery core, and relieved weld plate 202 may be positioned over a center of the battery core. In particular, a center of the battery core may be defined by a mandrel (e g , mandrel 140 of FIG. 1) extending longitudinally from a base of the battery.

Additionally relieved weld plate 202 includes first pathway 226, second pathway 228, and third pathway 230. First pathway 226, second pathway 228, and third pathway 230 are interstitial pathways defining open areas between relieved edges (e.g., first edge 232, third edge 236, and fifth edge 240) of the relieved weld plate 202 and a surface of battery housing 214. The interstitial pathways (e.g., first pathway 226, second pathway 228, and third pathway 230) are configured for ingress and/or egress of material into the battery core.

Relieved regions of relieved weld plate 202 form first edge 232, third edge 236, and fifth edge 240. Additionally, relieved weld plate 202 includes second edge 234, fourth edge 238, and sixth edge 242 forming a boundary between conductive face 204 and a surface of battery housing 214. In an implementation of the invention, second edge 234, fourth edge 238, and sixth edge 242 may be affixed to a surface of one or more spirals of electrode 218 by a welding operation.

In cathode relieved weld plate configurations, relieved weld plate 202 may include tab 210. Tab 210 may be a metallic strip extending radially outward from the center of relieved weld plate 202 and configured to be affixed (e.g., by welding) to terminal cap (e.g., terminal cap 112) of a battery. Further, cathode relieved weld plate configurations of relieved weld plate 202 may include a hollow region (e.g., hollow region 106 of FIG. 1). In anode relieved weld plate configurations, relieved weld plate 202 (e.g., an anode relieved weld plate) may include a contact region (e.g., contact region 126 of FIG. 1) (not depicted in FIG. 2). The contact region may have substantially the same features and functionality as contact region 126 of FIG. 1.

First conductive face 204 may be configured to be affixed to one or more concentric spirals (e.g., areas) of electrode 218. For instance, first conductive face 204 may be welded onto one or more concentric spirals of electrode 218 by known welding techniques (e.g., laser welding, ultrasonic welding). The interstitial pathways (e.g., first interstitial pathway 226, second interstitial pathway 228, and third interstitial pathway 230) are configured to provide access to inner spirals (e.g., inner areas) of the concentric spirals of electrode 218 so that, in addition to one or more outer spirals (e.g., outer areas), inner spirals also may be affixed to first conductive face 204. To elaborate and as an example, inner concentric spirals of electrode 218 may be illuminated by laser light through the interstitial pathways (e.g., first interstitial pathway 226, second interstitial pathway 228, third interstitial pathway 230) for welding those inner concentric spirals to first conductive face 204. By enabling inner concentric spirals (in addition to outer concentric spirals) of electrode 218 to be welded to first conductive face 204, a larger surface area of conductive face 204 may electrically contact electrode 218 than in the absence of interstitial pathways (e.g., first interstitial pathway 226, second interstitial pathway 228, and third interstitial pathway 230). By electrically contacting a larger surface area of first conductive face 204 to concentric spirals of electrode 218, an electrical resistance of relieved weld plate 202 may be reduced. By reducing an electrical resistance of relieved weld plate 202, a total electrical resistance of a battery may be reduced.

In addition to reducing an electrical resistance of relieved weld plate 202, the interstitial pathways of FIG. 2 provide a large area for rapid ingress of materials, such as introduction or reintroduction of electrolyte into the battery core, and for rapid egress of materials, such as gasses, out of the battery core. For instance, a viscous electrolyte may be poured into the battery core through the interstitial pathways of FIG. 2. In the absence of the interstitial pathways or if the interstitial pathways had a smaller area, introducing or reintroduction of viscous electrolyte into the battery core would take more time thereby decreasing manufacturing efficiency. As another example, gasses produced through electrolytic reactions occurring in the battery may escape through the interstitial pathways, thereby reducing an internal pressure of the battery and thus enhancing battery safety. In an example, a cumulative area of the interstitial pathways (i.e., a cumulative area of first interstitial pathway 226, second interstitial pathway 228, and third interstitial pathway 230) may be between 40 mm² and 226 mm².

Relieving conductive material from a weld plate to form interstitial pathways (e.g., first interstitial pathway 226, second interstitial pathway 228, etc.) reduces an overall surface area of first conductive face 204 available to electrically contact concentric spirals of electrode 218. However, an effect of this loss of conductive material on an overall electrical resistance of relieved weld plate 202 may be offset by an increased accessibility of inner concentric spirals of electrode 208 to welding devices. As explained above, a position, an orientation, and an area of the interstitial pathways (e.g., first interstitial pathway 226, second interstitial pathway 228, etc.) may render inner concentric spirals of electrode 218 more accessible to welding devices (e.g., lasers) thereby increasing a number of inner concentric spirals of electrode 218 that may be affixed to first conductive face 204 in the absence of the interstitial pathways. Hence, inclusion of interstitial pathways having the position, orientation, and area of topology 200 may offset a loss of conducting material resulting from relief of the weld plate. In the example of FIG. 2, an area of first conductive face 204 configured to be a component of a relieved cathode weld plate electrode may be between approximately 20 mm² and 425 mm². In the example of FIG. 2, an area of first conductive face 204 configured to be a component of a relieved anode weld plate electrode may be between approximately 35 mm² and 450 mm².

FIG. 3 depicts relieved weld plate 302 (e.g., a cathode relieved weld plate, an anode relieved weld plate, etc.) configured according to second topology 300 shown from a perspective of the coordinate system of FIG. 3. As depicted in FIG. 3, relieved weld plate 302 has the dimensions set forth in FIG. 3; however, these dimensions are exemplary. A relieved weld plate configured according to the second topology 300 may have dimensions different from those set forth in FIG. 3.

In the example of FIG. 3, relieved weld plate 302 includes first conductive face 304. First conductive face 304 is disposed on a side of relieved weld plate 302 that faces a battery core for electrically connecting to a battery core by contacting at least a portion of electrode 318 (e.g., cathode electrode, anode electrode). Electrode 318 is positioned longitudinally within battery housing 314 and is a part of the battery core (e.g., comprising a cathode, anode, and separator) of a battery. Concentric spirals of electrode 318 extend radially outward from a center of the battery core, and relieved weld plate 302 may be positioned over a center of the battery core. In particular, a center of the battery core may be defined by a mandrel (e.g., mandrel 140 of FIG. 1) extending longitudinally from a base of the battery. In this manner, center 344 of relieved weld plate 302 may be aligned with the mandrel of the battery.

Additionally relieved weld plate 302 includes first pathway 326, second pathway 328, and third pathway 330, and fourth pathway 334. First pathway 326, second pathway 328, third pathway 330, and fourth pathway 334 are interstitial pathways defining open areas between relieved edges (e.g., first edge 344, second edge 346, etc.) of relieved weld plate 302 and a surface of battery housing 314. The interstitial pathways (e.g., first pathway 326, second pathway 328, third pathway 330, and fourth pathway 334) are configured for ingress and/or egress of material into the battery core. As illustrated in FIG. 3, the interstitial pathways are configured to expose quadrants of the battery core, thereby facilitating rapid introduction, reintroduction, or removal of material from the battery core. In the example of FIG. 3, the quadrants corresponding to the interstitial pathways are of roughly equal area. However, in other implementations of the invention, the quadrants might be of different areas. For instance, an area of first interstitial pathway 326 may be greater than an area of second interstitial pathway 328.

Relieved weld plate 302 includes first member 336, second member 338, third member 340, and fourth member 342 (collectively referred to as “members”) extending radially outward from center 344 of relieved weld plate 302. By extending radially outward into each quadrant of the battery core, the members are configured to electrically contact inner concentric spirals (e.g., inner areas) and outer concentric spirals (e.g., outer areas) of electrode 318 in each quadrant of the battery core. Thus, second topology 300 may reduce an electrical resistance of relieved weld plate 302 by providing a relatively large surface area of first conductive face 304 available to electrically contact inner and outer concentric spirals of electrode 318.

As illustrated in FIG. 3, certain edges (e.g., first edge 346, second edge 348, etc.) of relieved weld plate 302 form substantially right angles with one another. Other edges (e.g., third edge 350, fourth edge 352, etc.) of relieved weld plate 302 may be configured to contact one or more spirals of electrode 318. In embodiments of the invention, edges, such as third edge 350 and fourth edge 352 may be welded onto one or more spirals of electrode 318.

The plurality of edges (e.g., first edge 346, second edge 348, third edge 350, fourth edge 352, etc.) of relieved weld plate 302 may be formed from a relief area of relieved weld plate 302. For instance, conductive material comprising relieved weld plate 302 may be sintered according to topology 300. In other implementations, a relief area defining the plurality of edges and defining first member 336, second member 338, third member 340, and fourth member 342 may be mechanically stamped out of conductive material comprising relieved weld plate 302. As another example, three dimensional metal printing technology can be used to print relieved weld plate 302. The simplicity of second topology 300 translates into a relative ease of manufacture of relieved weld plate 302, since a machine (e.g., a laser sintering machine) can be easily programmed to cut (e.g., sinter) conductive material in a pattern corresponding to second topology 300 or otherwise deposit conductive material in the patter of second topology 300.

In cathode relieved weld plate configurations, relieved weld plate 302 may include tab 310 having similar features and functionality as tab 110 of FIG. 1. Further, cathode relieved weld plate configurations of relieved weld plate 302 may include a hollow region (e.g., hollow region 106 of FIG. 1). In anode relieved weld plate configurations, relieved weld plate 302 (e.g., an anode relieved weld plate) may include a contact region (e.g., contact region 126 of FIG. 1) (not depicted in FIG. 2). The contact region may have substantially the same features and functionality as contact region 126 of FIG. 1.

First conductive face 304 may be configured to be affixed to one or more concentric spirals of electrode 318. For instance, first conductive face 304 may be welded onto one or more concentric spirals of electrode 318 by known welding techniques (e.g., laser welding, ultrasonic welding, etc.). The interstitial pathways (e.g., first interstitial pathway 326, second interstitial pathway 328, third interstitial pathway 330, and fourth interstitial pathway 334) are configured to provide access to inner spirals of the concentric spirals of electrode 318 so that, in addition to one or more outer spirals, inner spirals also may be affixed to first conductive face 304. To elaborate and as an example, inner concentric spirals of electrode 318 may be accessible to a welding apparatus (e.g., a laser) through the interstitial pathways (e.g., first interstitial pathway 326, second interstitial pathway 328, etc.) for welding those inner concentric spirals to first conductive face 304. By enabling inner concentric spirals (in addition to outer concentric spirals) of electrode 318 to be welded to first conductive face 304, a larger surface area of conductive face 304 may electrically contact electrode 318 than in the absence of interstitial pathways (e.g., first interstitial pathway 326, second interstitial pathway 328, etc.). By electrically contacting a larger surface area of first conductive face 304 to concentric spirals of electrode 318, an electrical resistance of relieved weld plate 302 may be reduced. By reducing an electrical resistance of relieved weld plate 302, a total electrical resistance of a battery may be reduced.

Further, as illustrated in FIG. 3, each interstitial pathway (e.g., first interstitial pathway 326, second interstitial pathway 328) renders accessible a quadrant of the battery core. Thus, a potentially larger number of concentric spirals of electrode 318 may be accessible (e.g., to a welding apparatus) than in other relieved weld plate topologies. Additionally, topology 300 may facilitate orientation of a welding apparatus to enhance the efficiency of a welding operation. To elaborate, a welding apparatus positioned above (i.e., in a z direction of the coordinate system) or below (i.e., in a z direction of the coordinate system) of center 344 of relieved weld plate 302 may be configured to swivel on a gimbal to easily access each quadrant corresponding to each interstitial pathway of relieved weld plate 302.

In addition to reducing an electrical resistance of relieved weld plate 302, the interstitial pathways of FIG. 3 provide a large area for rapid ingress of materials, such as introduction or reintroduction of electrolyte, into the battery core and for rapid egress of materials, such as gasses, out of the battery core. For instance, a viscous electrolyte may be poured into the battery core through the interstitial pathways of FIG. 3. In the absence of the interstitial pathways or if the interstitial pathways had a smaller area, introducing or reintroduction of viscous electrolyte into the battery core would take more time thereby decreasing manufacturing efficiency. As another example, gasses (e.g., produced via electrolytic chemical reactions) may escape from the pathways, thereby reducing an internal pressure of the battery and maintaining battery safety. In an example, a cumulative area of the interstitial pathways (i.e., a cumulative area of first interstitial pathway 326, second interstitial pathway 328, third interstitial pathway 330, and fourth interstitial pathway 332) may be between 100 mm² and 125 mm².

Relieving conductive material from a weld plate to form interstitial pathways (e.g., first interstitial pathway 326, second interstitial pathway 328, etc.) reduces an overall surface area of first conductive face 304 available to electrically contact concentric spirals of electrode 318. However, an effect of this loss of conductive material on overall electrical resistance of relieved weld plate 302 may be offset by an increased accessibility of inner concentric spirals of electrode 308 to welding devices. As explained above, a position, an orientation, and an area of the interstitial pathways (e.g., first interstitial pathway 326, second interstitial pathway 328, etc.) may render inner concentric spirals of electrode 318 more accessible to welding devices (e.g., lasers) thereby increasing a number of inner concentric spirals of electrode 318 that may be affixed to first conductive face 304 in the absence of the interstitial pathways. Hence, inclusion of interstitial pathways having the position, orientation, and area of second topology 300 may offset a loss of conductive material resulting from relief of the weld plate. In the example of FIG. 3, an area of first conductive face configured to be a component of a relieved cathode weld plate electrode may be between 100 mm² and 122 mm² In the example of FIG. 3, an area of first conductive face 304 configured to be a component of a relieved anode weld plate electrode may be between 130 mm² and 150 mm².

FIG. 4 depicts relieved weld plate 402 (e.g., a cathode relieved weld plate, an anode relieved weld plate, etc.) configured according to third topology 400 shown from a perspective of the coordinate system of FIG. 4. As depicted in FIG. 4, relieved weld plate 402 has the dimensions set forth in FIG. 4; however, these dimensions are exemplary. A relieved weld plate configured according to the second topology 300 may have dimensions different from those set forth in FIG. 4.

In the example of FIG. 4, relieved weld plate 402 includes first conductive face 404. First conductive face 404 is disposed on a side of relieved weld plate 402 that faces a battery core for electrically connecting to a battery core by contacting at least a portion of electrode 418 (e.g., cathode electrode, anode electrode). Electrode 418 is positioned longitudinally within battery housing 414 and is a part of the battery core (e.g., comprising a cathode, anode, and separator) of a battery. Concentric spirals of electrode 418 extend radially outward from a center of the battery core, and relieved weld plate 402 may be positioned over a center of the battery core. In particular, a center of the battery core may be defined by a mandrel (e.g., mandrel 140 of FIG. 1) extending longitudinally from a base of the battery. In this manner, center 444 of relieved weld plate 402 may be aligned with the mandrel of the battery.

Additionally, relieved weld plate 402 includes first pathway 426, second pathway 428, and third pathway 430, and fourth pathway 434. First pathway 426, second pathway 428, third pathway 430, and fourth pathway 432 are interstitial pathways defining open areas between certain relieved edges (e.g., first edge 446, second edge 450, etc.) of relieved weld plate 402 and a surface of battery housing 414. The interstitial pathways (e.g., first pathway 426, second pathway 428, etc.) are configured for ingress and/or egress of material into the battery core. As illustrated in FIG. 4, the interstitial pathways are configured to expose parabolic quadrants of the battery core, thereby facilitating rapid introduction, reintroduction, and/or removal of material from the battery core. In the example of FIG. 4, the parabolic quadrants corresponding to the interstitial pathways provide access to inner and outer concentric spirals of electrode 418. In particular and as shown in FIG. 4, the parabolic shape of the interstitial pathways provide access to inner concentric spirals (e.g., inner areas) of electrode 418 that might otherwise be inaccessible if the interstitial pathways had a different topology. In the example of FIG. 4, the interstitial pathways have approximately equal areas; however, in other implementations, the interstitial pathways may have different areas. For instance, an area corresponding to first interstitial pathway 426 may be less than an area corresponding to second interstitial pathway 428.

Relieved weld plate 402 includes first member 436, second member 438, third member 440, and fourth member 442 extending radially outward from center 444 of relieved weld plate 402 (collectively referred to as “members”). The members increase in surface area radially from center 444 of relieved weld plate 402. Thus, an area of a portion of a member closer to battery surface 414 is greater than an area of a portion of the member that is closer to center 444 of relieved weld plate 402. The radially expanding members provide an increased surface area for contact between outer concentric spirals (e.g., outer areas) of electrode 418 and first conductive face 404 thereby decreasing an electrical resistance of relieved weld plate 402. Further, by electrically contacting each quadrant of the inner core of the battery, the members provide a relatively large surface area available for first conductive face 404 to electrically contact inner concentric spirals (e.g., inner areas) and outer concentric spirals (e.g., outer areas) of electrode 418. In this manner, third topology 400 may be configured to reduce an overall electrical resistance of relieved weld plate 402. By reducing an electrical resistance of relieved weld plate 402, third topology 400 may reduce an electrical resistance of the battery, thereby enhancing battery operation.

As illustrated in FIG. 4, certain edges (e.g., first edge 446, second edge 450 etc.) of relieved weld plate 402 form a boundary between first conductive face 404 of relieved weld plate 402 and an interstitial pathway (e.g., first interstitial pathway 426, second interstitial pathway 428, etc.). Other edges (e.g., third edge 448, fourth edge 452, etc.) of relieved weld plate 402 may be configured to contact one or more spirals of electrode 418. In embodiments of the invention, edges, such as third edge 448 and fourth edge 452 may be welded onto one or more spirals of electrode 418.

The plurality of edges (e.g., first edge 446, second edge 450, third edge 452, etc.) of relieved weld plate 402 may be formed from a relief area of relieved weld plate 402. For instance, conductive material comprising relieved weld plate 402 may be sintered according to topology 400. In other implementations, a relief area defining the plurality of edges and defining first member 436, second member 438, third member 440, and fourth member 442 may be mechanically stamped out of conductive material comprising relieved weld plate 402. As another example, conductive material may be deposited according to topology 400 using three dimensional metal printing technology. The simplicity of third topology 400 translates into a relative ease of manufacture of relieved weld plate 402, since a machine (e.g., a laser sintering machine) can be easily programmed to cut (e.g., sinter) conductive material in a pattern corresponding to third topology 400 or to deposit conductive material according to third topology 400.

In cathode relieved weld plate configurations, relieved weld plate 402 may include tab 410 having similar features and functionality as tab 110 of FIG. 1. Further, cathode relieved weld plate configurations of relieved weld plate 402 may include a hollow region (e.g., hollow region 106 of FIG. 1). In anode relieved weld plate configurations, relieved weld plate 402 (e.g., an anode relieved weld plate) may include a contact region (e.g., contact region 126 of FIG. 1). The contact region may have substantially the same features and functionality as contact region 126 of FIG. 1.

First conductive face 404 may be configured to be affixed to one or more concentric spirals of electrode 418. For instance, first conductive face 404 may be welded onto one or more concentric spirals of electrode 418 by known welding techniques (e.g., laser welding, ultrasonic welding, etc.). The interstitial pathways (e.g., first interstitial pathway 426, second interstitial pathway 428, third interstitial pathway 430, and fourth interstitial pathway 432) are configured to provide access to inner spirals of the concentric spirals of electrode 418 so that, in addition to one or more outer spirals, inner spirals also may be affixed to first conductive face 404. To elaborate and as an example, inner concentric spirals of electrode 418 may be accessible to a welding apparatus (e.g., a laser) through the parabolic interstitial pathways (e.g., first interstitial pathway 426, second interstitial pathway 428, etc.) for welding those inner concentric spirals to first conductive face 404. By enabling inner concentric spirals (in addition to outer concentric spirals) of electrode 418 to be welded to first conductive face 404, a larger surface area of conductive face 404 may electrically contact electrode 418 than in the absence of interstitial pathways (e.g., first interstitial pathway 426, second interstitial pathway 428, etc.) or with interstitial pathways having different topologies. By electrically contacting a larger surface area of first conductive face 404 to concentric spirals of electrode 418, an electrical resistance of relieved weld plate 402 may be reduced. By reducing an electrical resistance of relieved weld plate 402, a total electrical resistance of a battery may be reduced.

In addition to reducing an electrical resistance of relieved weld plate 402, the interstitial pathways of FIG. 4 provide a large area for rapid ingress of materials, such as introduction or reintroduction of electrolyte, into the battery core and for rapid egress of materials, such as gasses, out of the battery core. For instance, a viscous electrolyte may be poured into the battery core through the interstitial pathways of FIG. 4. In the absence of the interstitial pathways or if the interstitial pathways had a smaller area, introducing or reintroduction of viscous electrolyte into the battery core would take more time thereby decreasing manufacturing efficiency. In an example, a cumulative area of the interstitial pathways (i.e., a cumulative area of first interstitial pathway 426, second interstitial pathway 428, third interstitial pathway 430, and fourth interstitial pathway 432) may be between 87 mm² and 107 mm².

Relieving conductive material from a weld plate to form interstitial pathways (e.g., first interstitial pathway 426, second interstitial pathway 428, etc.) reduces an overall surface area of first conductive face 404 available to electrically contact concentric spirals of electrode 418. However, an effect of this loss of conductive material on overall electrical resistance of relieved weld plate 402 may be offset by an increased accessibility of inner concentric spirals of electrode 418 to welding devices. As explained above, a position, an orientation, and an area of the interstitial pathways (e.g., first interstitial pathway 426, second interstitial pathway 428, etc.) may render inner concentric spirals of electrode 418 more accessible to welding devices (e.g., lasers) thereby increasing a number of inner concentric spirals of electrode 418 that may be affixed to first conductive face 404 in the absence of the interstitial pathways. Hence, inclusion of interstitial pathways having the position, orientation, and area of topology 400 may offset a loss of conductive material resulting from relief of the weld plate. Moreover, since a surface area of the members (e.g., first member 436, second member 438) increases radially, one or more outer concentric spirals of electrode 418 may electrically contact first conductive face 404 thereby further offsetting the loss of conductive material resulting from the presence of the interstitial pathways. In the example of FIG. 4, an area of first conductive face configured to be a component of a relieved cathode weld plate electrode may be between 133 mm² and 161 mm². In the example of FIG. 4, an area of first conductive face 404 configured to be a component of a relieved anode weld plate electrode may be between 141 mm² and 172 mm².

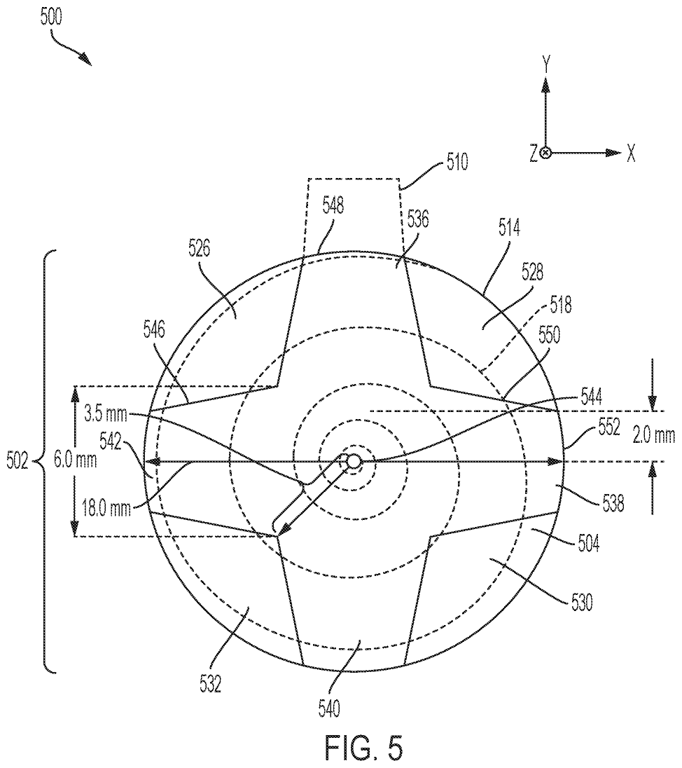

FIG. 5 depicts relieved weld plate 502 (e.g., a cathode relieved weld plate, an anode relieved weld plate, etc.) configured according to fourth topology 500 shown from a perspective of the coordinate system of FIG. 5. As depicted in FIG. 5, relieved weld plate 502 has the dimensions set forth in FIG. 5; however, these dimensions are exemplary. A relieved weld plate configured according to the fourth topology 500 may have dimensions different from those set forth in FIG. 5.

In the example of FIG. 5, relieved weld plate 502 includes first conductive face 504. First conductive face 504 is disposed on a side of relieved weld plate 502 that faces a battery core for electrically connecting to a battery core by contacting at least a portion of electrode 518 (e.g., cathode electrode, anode electrode). Electrode 518 is positioned longitudinally within battery housing 514 and is a part of the battery core (e.g., comprising a cathode, anode, and separator) of a battery. Concentric spirals of electrode 518 extend radially outward from a center of the battery core, and relieved weld plate 502 may be positioned over a center of the battery core. In particular, a center of the battery core may be defined by a mandrel (e.g., mandrel 140 of FIG. 1) extending longitudinally from a base of the battery. In this manner, center 544 of relieved weld plate 502 may be aligned with the mandrel of the battery.

Additionally, relieved weld plate 502 includes first pathway 526, second pathway 528, and third pathway 530, and fourth pathway 532. First pathway 526, second pathway 528, third pathway 530, and fourth pathway 532 are interstitial pathways defining open areas between certain relieved edges (e.g., first edge 546, second edge 550, etc.) of relieved weld plate 502 and a surface of battery housing 514. The interstitial pathways (e.g., first pathway 526, second pathway 528, etc.) are configured for ingress and/or egress of material into the battery core. As illustrated in FIG. 5, the interstitial pathways are configured to expose quadrants of the battery core, thereby facilitating rapid introduction, reintroduction, and/or removal of material from the battery core. In the example of FIG. 5, the interstitial pathways have approximately equal areas; however, in other implementations, the interstitial pathways may have different areas. For instance, an area corresponding to first interstitial pathway 526 may be less than an area corresponding to second interstitial pathway 528.

Relieved weld plate 502 includes first member 536, second member 538, third member 540, and fourth member 542 extending radially outward from center 544 of relieved weld plate 502 (collectively referred to as “members”). The members are tapered, decreasing in surface area radially from center 544 of relieved weld plate 502. Thus, an area of a portion of a member closer to battery surface 514 is less than an area of a portion of the member that is closer to center 544 of relieved weld plate 502. The tapered members (e.g. first member 536, second member 538, etc.) provide a large surface area of first conductive face 504 to electrically contact inner concentric spirals (e.g., inner areas) of electrode 518, while also providing sufficient area for interstitial pathways. Further, by electrically contacting each quadrant of the inner core of the battery, the members provide a relatively large surface area available for first conductive face 504 to electrically contact inner concentric spirals (e.g., inner areas) and outer concentric spirals (e.g., outer areas) of electrode 518. In this manner, fourth topology 500 may be configured to reduce an overall electrical resistance of relieved weld plate 502. By reducing an electrical resistance of relieved weld plate 502, fourth topology 500 may reduce an electrical resistance of the battery, thereby enhancing battery operation.

As illustrated in FIG. 5, certain edges (e.g., first edge 546, second edge 550 etc.) of relieved weld plate 502 form a boundary between first conductive face 504 of relieved weld plate 502 and an interstitial pathway (e.g., first interstitial pathway 526, second interstitial pathway 528, etc.). Other edges (e.g., third edge 548, fourth edge 552, etc.) of relieved weld plate 502 may be configured to contact one or more spirals of electrode 518. In embodiments of the invention, edges, such as third edge 548 and fourth edge 552 may be welded onto spirals of electrode 518.

The plurality of edges (e.g., first edge 546, second edge 550, third edge 552, etc.) of relieved weld plate 502 may be formed from a relief area of relieved weld plate 502. For instance, conductive material comprising relieved weld plate 502 may be sintered according to fourth topology 500. In other implementations, a relief area defining the plurality of edges and defining first member 536, second member 538, third member 540, and fourth member 542 may be mechanically stamped out of conductive material comprising relieved weld plate 502. As another example, conductive material may be deposited according to the pattern of fourth topology 500 through use of three dimensional metal printing technology. The simplicity of fourth topology 500 translates into a relative ease of manufacture of relieved weld plate 502, since a machine (e.g., a laser sintering machine) can be easily programmed to cut (e.g., sinter) conductive material in a pattern corresponding to fourth topology 500 or to deposit conductive material according to the pattern corresponding to fourth topology 500.

In cathode relieved weld plate configurations, relieved weld plate 502 may include tab 510 having similar features and functionality as tab 110 of FIG. 1. Further, cathode relieved weld plate configurations of relieved weld plate 502 may include a hollow region (e.g., hollow region 106 of FIG. 1). In anode relieved weld plate configurations, relieved weld plate 502 (e.g., an anode relieved weld plate) may include a contact region (e.g., contact region 126 of FIG. 1). The contact region may have substantially the same features and functionality as contact region 126 of FIG. 1.

First conductive face 504 may be configured to be affixed to one or more concentric spirals of electrode 518. For instance, first conductive face 504 may be welded onto one or more concentric spirals of electrode 518 by known welding techniques (e.g., laser welding, ultrasonic welding, etc.). The interstitial pathways (e.g., first interstitial pathway 526, second interstitial pathway 528, third interstitial pathway 530, and fourth interstitial pathway 532) are configured to provide access to inner spirals of the concentric spirals of electrode 418 so that, in addition to one or more outer spirals, inner spirals also may be affixed to first conductive face 504. To elaborate and as an example, inner concentric spirals of electrode 518 may be accessible to a welding apparatus (e.g., a laser) through the interstitial pathways (e.g., first interstitial pathway 526, second interstitial pathway 528, etc.) for welding those inner concentric spirals to first conductive face 504. By enabling inner concentric spirals (in addition to outer concentric spirals) of electrode 518 to be welded to first conductive face 504, a larger surface area of conductive face 504 may electrically contact electrode 518 than in the absence of interstitial pathways (e.g., first interstitial pathway 526, second interstitial pathway 528, etc.) or with interstitial pathways having different topologies. By electrically contacting a larger surface area of first conductive face 504 to concentric spirals of electrode 518, an electrical resistance of relieved weld plate 502 may be reduced. By reducing an electrical resistance of relieved weld plate 502, a total electrical resistance of a battery may be reduced.

In addition to reducing an electrical resistance of relieved weld plate 502, the interstitial pathways of FIG. 5 provide a large area for rapid ingress of materials, such as introduction or reintroduction of electrolyte. into the battery core and for rapid egress of materials, such as gasses, out of the battery core. For instance, a viscous electrolyte may be poured into the battery core through the interstitial pathways of FIG. 5. In the absence of the interstitial pathways or if the interstitial pathways had a smaller area, introducing or reintroduction of viscous electrolyte into the battery core would take more time thereby decreasing manufacturing efficiency. In an example, a cumulative area of the interstitial pathways (i.e., a cumulative area of first interstitial pathway 526, second interstitial pathway 528, third interstitial pathway 530, and fourth interstitial pathway 532) may be between 100 mm² and 124 mm².

Relieving conductive material from a weld plate to form interstitial pathways (e.g., first interstitial pathway 526, second interstitial pathway 528, etc.) reduces an overall surface area of first conductive face 504 available to electrically contact concentric spirals of electrode 518. However, an effect of this loss of conductive material on overall electrical resistance of relieved weld plate 502 may be offset by an increased accessibility of inner concentric spirals of electrode 518 to welding devices, as explained in the context of FIG. 2. Further, as illustrated in FIG. 5, by tapering the members (e.g., first member 536, second member 538, etc.) so that a surface area of the members is greater closer to center 544 of relieved weld plate 502 than further from center 544, a larger contact area is provided for inner concentric spirals of electrode 518 to electrically contact relieved weld plate 502. In the example of FIG. 5, an area of first conductive face 504 configured to be a component of a relieved cathode weld plate electrode may be between 118 mm² and 145 mm². In the example of FIG. 5, an area of first conductive face 504 configured to be a component of a relieved anode weld plate electrode may be between 124 mm² and 155 mm²

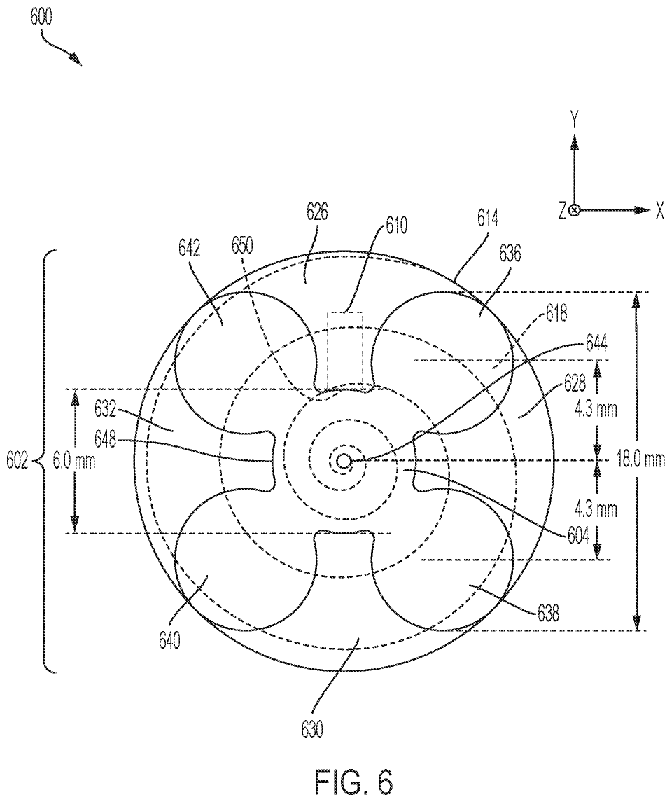

FIG. 6 depicts relieved weld plate 602 (e.g., a cathode relieved weld plate, an anode relieved weld plate, etc.) configured according to fifth topology 600 shown from a perspective of the coordinate system of FIG. 6. As depicted in FIG. 6, relieved weld plate 602 has the dimensions set forth in FIG. 6; however, these dimensions are exemplary. A relieved weld plate configured according to the fifth topology 600 may have dimensions different from those set forth in FIG. 6.

In the example of FIG. 6, relieved weld plate 602 includes first conductive face 604. First conductive face 604 is disposed on a side of relieved weld plate 602 that faces a battery core for electrically connecting to a battery core by contacting at least a portion of electrode 618 (e.g., cathode electrode, anode electrode). Electrode 618 is positioned longitudinally within battery housing 614 and is a part of the battery core (e.g., comprising a cathode, anode, and separator) of a battery. Concentric spirals of electrode 618 extend radially outward from a center of the battery core, and relieved weld plate 602 may be positioned over a center of the battery core. In particular, a center of the battery core may be defined by a mandrel (e.g., mandrel 140 of FIG. 1) extending longitudinally from a base of the battery. In this manner, center 644 of relieved weld plate 602 may be aligned with the mandrel of the battery.

Additionally, relieved weld plate 602 includes first pathway 626, second pathway 628, and third pathway 630, and fourth pathway 632. First pathway 626, second pathway 628, third pathway 630, and fourth pathway 632 are interstitial pathways defining open areas between certain relieved edges (e.g., first edge 648, second edge 650, etc.) of relieved weld plate 602 and a surface of battery housing 614. The interstitial pathways (e.g., first pathway 626, second pathway 628, etc.) are configured for ingress and/or egress of material into the battery core. In the example of FIG. 6, the interstitial pathways have approximately equal areas; however, in other implementations, the interstitial pathways may have different areas. For instance, an area corresponding to first interstitial pathway 626 may be less than an area corresponding to second interstitial pathway 628.

Relieved weld plate 602 includes first member 636, second member 638, third member 640, and fourth member 642 (collectively referred to as members) protruding outward from a central region of first conductive face 604. The members are approximately circular appendages configured to contact outer concentric spirals of electrode 618, while the central region of first conductive face 604 is configured to contract inner concentric spirals (e.g., inner areas) of electrode 618. In the example of FIG. 6, center 644 of relieved weld plate 602 may be equidistant to first edge 648 and to second edge 650.

Fifth topology 600 may be more difficult to manufacture than first topology 200—fourth topology 400. However, fifth topology 600 may provide a larger area of interstitial pathways (e.g., first interstitial pathway 626, second interstitial pathway 628, etc.) than the topologies described in FIGS. 2-5. Additionally, fifth topology 600 balances space allocated for interstitial pathways against a surface area of first conductive face 604 available to electrically contact inner concentric spirals of electrode 618 and outer concentric spirals of electrode 618. To elaborate, the circular members (e.g., first member 636, second member 638, etc.) provide a surface area of first conductive face 604 to electrically contact outer concentric spirals (e.g., outer areas) of electrode 618, while the central region of first conductive face 604 provides a surface area to contact inner concentric spirals (e.g., inner areas) of electrode 618. Moreover, fifth topology 600 provides a relatively large surface area available for interstitial pathways (e.g., first interstitial pathway 626, second interstitial pathway 628, etc.) so that inner concentric spirals of electrode 618 are accessible, through the interstitial pathways, to a welding apparatus (e.g., laser) thereby facilitating affixing of first conductive face 604 onto electrode 618. By enabling inner concentric spirals (in addition to outer concentric spirals) of electrode 618 to be welded to first conductive face 604, a larger surface area of first conductive face 604 may electrically contact electrode 618 than in the absence of interstitial pathways (e.g., first interstitial pathway 626, second interstitial pathway 628, etc.) or with interstitial pathways having different topologies. By electrically contacting a larger surface area of first conductive face 604 to concentric spirals of electrode 618, an electrical resistance of relieved weld plate 602 may be reduced. By reducing an electrical resistance of relieved weld plate 602, a total electrical resistance of a battery may be reduced.

In cathode relieved weld plate configurations, relieved weld plate 602 may include tab 610 having similar features and functionality as tab 110 of FIG. 1. Further, cathode relieved weld plate configurations of relieved weld plate 602 may include a hollow region (e.g., hollow region 106 of FIG. 1). In anode relieved weld plate configurations, relieved weld plate 562 (e.g., an anode relieved weld plate) may include a contact region (e.g., contact region 126 of FIG. 1). The contact region may have substantially the same features and functionality as contact region 126 of FIG. 1.

In addition to reducing an electrical resistance of relieved weld plate 602, the interstitial pathways of FIG. 6 provide a large area for rapid ingress of materials, such as electrolyte, into the battery core and for egress of materials, such as gasses, out of the battery core. For instance, a viscous electrolyte may be poured into the battery core through the interstitial pathways of FIG. 6. In the absence of the interstitial pathways or if the interstitial pathways had a smaller area, introducing or reintroduction of viscous electrolyte into the battery core would take more time thereby decreasing manufacturing efficiency. In an example, a cumulative area of the interstitial pathways (i.e., a cumulative area of first interstitial pathway 626, second interstitial pathway 628, third interstitial pathway 630, and fourth interstitial pathway 632) may be between 117 mm² and 146 mm². In the example of FIG. 6, an area of first conductive face 604 configured to be a component of a relieved cathode weld plate electrode may be between 105 mm² and 126 mm². In the example of FIG. 6, an area of first conductive face 604 configured to be a component of a relieved anode weld plate electrode may be between 112 mm² and 136 mm².

FIGS. 7-9 depict topologies of relieved weld plates (e.g., cathode relieved weld plates, anode relieved weld plates) in which full pathways are formed. The topologies of FIGS. 7-9 achieve different tradeoffs between an area of the conductive face of the relieved weld plates and an area of the interstitial pathways, respectively. For example, in some topologies, the surface area of the conductive face is larger than in other topologies resulting in the cumulative area of the interstitial pathways to be smaller than in other topologies. In embodiments, a percentage of a total surface area of a relieved weld plate constituting full vias and having one of the topologies of FIGS. 7-9 may be between 10%-25%.

In cathode relieved weld plate configurations of the topologies described in FIGS. 7-9, the relieved weld plate may include a tab (not illustrated) having similar features and functionality as tab 110 of FIG. 1. Further, cathode relieved weld plate configurations of relieved weld plates depicted in FIGS. 7-9 may include a hollow region (e.g., hollow region 106 of FIG. 1) positioned substantially at a center of the relieved weld plate. A pin (e.g., pin 140 of FIG. 1) enclosed in a mandrel (e.g., mandrel 142 of FIG. 1) positioned substantially at a center of a battery (e.g., as depicted in FIG. 1) may extend longitudinally from a base of the battery and may protrude outwards through the hollow region to electrically contact the anode (e.g., anode 136) of the battery to a terminal positioned on a cap of the battery.

In anode relieved weld plate configurations of the topologies described in FIGS. 7-9, the relieved weld plate may include a contact region (e.g., contact region 126 of FIG. 1). The contact region may have substantially the same features and functionality as contact region 126 of FIG. 1. The contact region may be positioned substantially at a center of the relieved weld plate to align with the mandrel (e.g., mandrel of FIG. 1), the pin (e.g., pin 140 of FIG. 1), and the hollow region of the cathode relieved weld plate so that the pin can extend longitudinally from the base of the battery to the terminal cap (e.g., terminal cap 112) of the battery.

In embodiments, a thickness (i.e., in a z dimension as shown in coordinate axes of FIGS. 7-9) of a relieved weld plate that corresponds to a cathode relieved weld plate may be between 0.25 mm to 1.5 mm. In embodiments, a thickness (i.e., in a z dimension as shown in coordinate axes of FIGS. 7-9) of a relieved weld plate that corresponds to an anode relieved weld plate may be between 0.15 mm to 1 mm. The foregoing thicknesses facilitate affixing the relieved weld plates to the cathode electrode or to the anode electrode, respectively. For instance, if a relieved weld plate has a smaller thickness than the foregoing thicknesses, a welding operation would be too difficult, because energy generated by the welding apparatus may vaporize portions of the relieved weld plate. Conversely, if a relieved weld plate has thickness greater than the foregoing thicknesses, excessive energy may be required to affix the relieved weld plate onto the electrode, thereby rendering a welding operation inefficient.

FIG. 7 depicts relieved weld plate 702 (e.g., a cathode relieved weld plate, an anode relieved weld plate, etc.) configured according to sixth topology 700 shown from a perspective of the coordinate system of FIG. 7. As depicted in FIG. 7, relieved weld plate 702 has the dimensions set forth in FIG. 7; however, these dimensions are exemplary. A relieved weld plate configured according to the sixth topology 700 may have dimensions different from those set forth in FIG. 7.

Relieved weld plate 702 may include full pathways positioned within relief areas of first conductive face 704. First conductive face 704 is disposed on a side of relieved weld plate 702 that faces a battery core for electrically connecting to a battery core by contacting at least a portion of electrode 718 (e.g., cathode electrode, anode electrode). Electrode 718 is positioned longitudinally within battery housing 714 and is a part of the battery core (e.g., comprising a cathode, anode, and separator) of a battery. Concentric spirals of electrode 718 extend radially outward from a center of the battery core, and relieved weld plate 702 may be positioned over a center of the battery core. In particular, a center of the battery core may be defined by a mandrel (e.g , mandrel 140 of FIG. 1) extending longitudinally from a base of the battery. In this manner, center 744 of relieved weld plate 702 may be aligned with the mandrel of the battery.

In the example of FIG. 7, the full pathways include first full pathway 720, second full pathway 722, third full pathway 724, and fourth full pathway 728 positioned to divide first conductive face 704 into quadrants and located approximately equidistantly from center 744 of relieved weld plate 702. The full pathways are positioned to provide access to inner concentric spirals (e.g., inner areas) of electrode 718. Thus, inner concentric spirals of electrode 718 may be accessible to a welding apparatus (e.g., laser) that may be configured to weld one or more inner concentric spirals of electrode 718 of electrode 718 to first conductive face 704. By electrically contacting inner concentric spirals of electrode 718 to first conductive face 704, an electrical resistance of relieved weld plate 702 may be reduced thereby reducing an overall electrical resistance of the battery. Hence, although the full pathways reduce a surface area of conductive face 704, by facilitating a welding operation so that inner concentric spirals of electrode 718 may electrically contact first conductive face 704, the full pathways may offset the loss of conductive material.

Further, the full pathways are positioned to facilitate the ingress of materials, such as electrolyte, into the battery core. The full pathways also facilitate the egress of materials, such as gasses, out of the battery core. By positioning full pathways close to center 744 of relieved weld plate 702 and by locating the full pathways so that each quadrant of the battery core is accessible, the full pathways are configured to provide sufficient access to the battery core to enable quick ingress of the materials into and quick egress of the materials out of the battery core. In an embodiment of the invention, a cumulative area of the full pathways (e.g., first full pathway 720, second full pathway 722, etc.) may be between 54 mm² and 66 mm².

In the example of FIG. 7, in a cathode relieved weld plate implementation of relieved weld plate 702, first conductive face 704 may have a surface area between 163 mm² and 199 mm². In an anode relieved weld plate implementation of relieved weld plate 702, first conductive face 704 may have a surface area between 175 mm² and 213 mm². Thus, sixth topology 700 provides a large surface area for electrical contact between conductive material of the relieved weld plate 702 and electrode 718.

FIG. 8 depicts relieved weld plate 802 (e.g., a cathode relieved weld plate, an anode relieved weld plate, etc.) configured according to seventh topology 800 shown from a perspective of the coordinate system of FIG. 8. As depicted in FIG. 8, relieved weld plate 802 has the dimensions set forth in FIG. 8; however, these dimensions are exemplary. A relieved weld plate configured according to the seventh topology 800 may have dimensions different from those set forth in FIG. 8.

Relieved weld plate 802 may include full pathways positioned within relief areas of first conductive face 804. First conductive face 804 is disposed on a side of relieved weld plate 802 that faces a battery core for electrically connecting to a battery core by contacting at least a portion of electrode 818 (e.g., cathode electrode, anode electrode). Electrode 818 is positioned longitudinally within battery housing 814 and is a part of the battery core (e.g., comprising a cathode, anode, and separator) of a battery. Concentric spirals of electrode 818 extend radially outward from a center of the battery core, and relieved weld plate 802 may be positioned over a center of the battery core. In particular, a center of the battery core may be defined by a mandrel (e.g , mandrel 140 of FIG. 1) extending longitudinally from a base of the battery. In this manner, center 844 of relieved weld plate 802 may be aligned with the mandrel of the battery.

In the example of FIG. 8, the full pathways include first full pathway 820, second full pathway 822, and third full pathway 824, positioned to divide first conductive face 804 into thirds and located approximately equidistantly from center 844 of relieved weld plate 802. Thus, inner concentric spirals (e.g., inner areas) of electrode 818 may be accessible to a welding apparatus (e.g., laser) that may be configured to weld one or more inner concentric spirals of electrode 818 to first conductive face 804. By electrically contacting inner concentric spirals of electrode 818 to first conductive face 804, an electrical resistance of relieved weld plate 802 may be reduced thereby reducing an overall electrical resistance of the battery. Hence, although the full pathways reduce a surface area of conductive face 804, by facilitating a welding operation so that inner concentric spirals of electrode 818 may electrically contact first conductive face 804, the full pathways may offset the loss of conductive material.

Further, the full pathways are positioned to facilitate the ingress of materials, such as electrolyte, into the battery core. The full pathways also facilitate the egress of materials, such as gasses, out of the battery core. By positioning full pathways close to center 844 of relieved weld plate 802 and by locating the full pathways so that each third of the battery core is accessible, the full pathways are configured to provide sufficient access to the battery core to enable quick ingress of the materials into and quick egress of the materials out of the battery core. In an embodiment of the invention, a cumulative area of the full pathways (e.g., first full pathway 820, second full pathway 822, etc.) may be between 45 mm² and 55 mm².

Additionally, unlike in the example of FIG. 7, in the example of FIG. 8, three full pathways are included instead of four full pathways. By reducing a number of full pathways, a surface area of first conductive face 804 may be larger than the surface area of first conductive face 704 of sixth topology 700. Therefore, weld plate 802 may have a lower electrical resistance than weld plate 702, since a larger surface area of first conductive face 804 is available to contact electrode 818 than the surface area of first conductive face 704 available electrode 718.

In the example of FIG. 8, in a cathode relieved weld plate implementation of relieved weld plate 802, first conductive face 804 may have a surface area between 173 mm² and 211 mm². In an anode relieved weld plate implementation of relieved weld plate 802, first conductive face 804 may have a surface area between 185 mm² and 225 mm². Thus, seventh topology 800 provides a large surface area for electrical contact between conductive material of the relieved weld plate 802 and electrode 818.

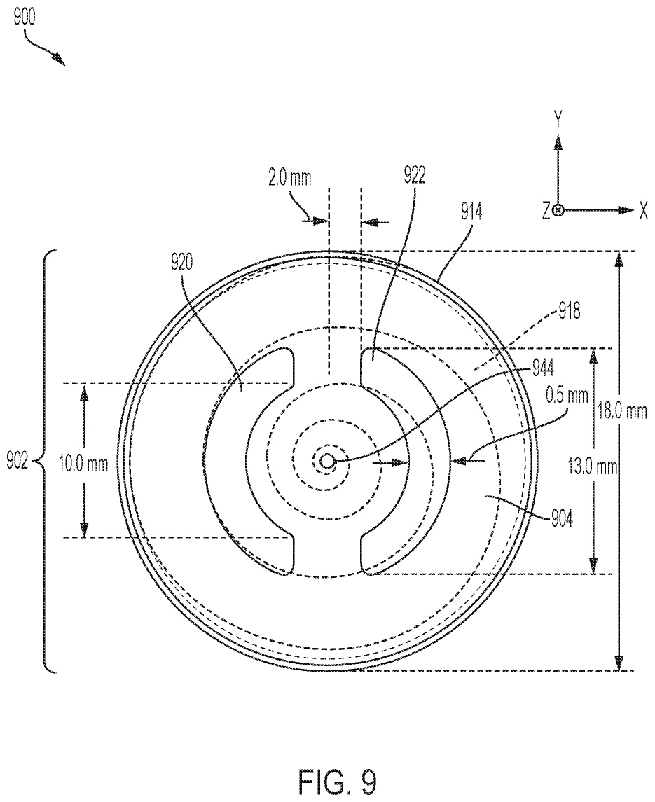

FIG. 9 depicts relieved weld plate 902 (e.g., a cathode relieved weld plate, an anode relieved weld plate, etc.) configured according to eighth topology 900 shown from a perspective of the coordinate system of FIG. 9. As depicted in FIG. 9, relieved weld plate 902 has the dimensions set forth in FIG. 9; however, these dimensions are exemplary. A relieved weld plate configured according to the eighth topology 900 may have dimensions different from those set forth in FIG. 9.

Relieved weld plate 902 may include full pathways positioned within relief areas of first conductive face 904. First conductive face 904 is disposed on a side of relieved weld plate 902 that faces a battery core for electrically connecting to a battery core by contacting at least a portion of electrode 918 (e.g., cathode electrode, anode electrode). Electrode 918 is positioned longitudinally within battery housing 914 and is a part of the battery core (e.g., comprising a cathode, anode, and separator) of a battery. Concentric spirals of electrode 918 extend radially outward from a center of the battery core, and relieved weld plate 902 may be positioned over a center of the battery core. In particular, a center of the battery core may be defined by a mandrel (e.g , mandrel 140 of FIG. 1) extending longitudinally from a base of the battery. In this manner, center 944 of relieved weld plate 902 may be aligned with the mandrel of the battery.

In the example of FIG. 9, the full pathways include first full pathway 920 and second full pathway 922. The full pathways are positioned to divide relieved weld plate 902 into halves. The full pathways are further configured to provide access to inner concentric spirals of electrode 918. Thus, inner concentric spirals (e.g., inner areas) of electrode 918 may be accessible to a welding apparatus (e.g., laser) that may be configured to weld one or more inner concentric spirals of electrode 918 to first conductive face 904. By electrically contacting inner concentric spirals of electrode 918 to first conductive face 904, an electrical resistance of relieved weld plate 902 may be reduced thereby reducing an overall electrical resistance of the battery. Hence, although the full pathways reduce a surface area of conductive face 904, by facilitating a welding operation so that inner concentric spirals of electrode 918 may electrically contact first conductive face 904, the full pathways may offset the loss of conductive material. In an embodiment of the invention, a cumulative area of the full pathways (e.g., first full pathway 920, second full pathway 922) may be between 55 mm² and 67 mm².

Further, the full pathways are positioned to facilitate the ingress of materials, such as electrolyte, into the battery core. The full pathways also facilitate the egress of materials, such as gasses, out of the battery core. By positioning full pathways close to center 944 of relieved weld plate 902 and by locating the full pathways so that each third of the battery core is accessible, the full pathways are configured to provide sufficient access to the battery core to enable quick ingress of the materials into and quick egress of the materials out of the battery core.

In the example of FIG. 9, in a cathode relieved weld plate implementation of relieved weld plate 902, first conductive face 904 may have a surface area between 162 mm² and 198 mm². In an anode relieved weld plate implementation of relieved weld plate 902, first conductive face 904 may have a surface area between 174 mm² and 212 mm². Thus, eighth topology 900 provides a large surface area for electrical contact between conductive material of the relieved weld plate 902 and electrode 918.

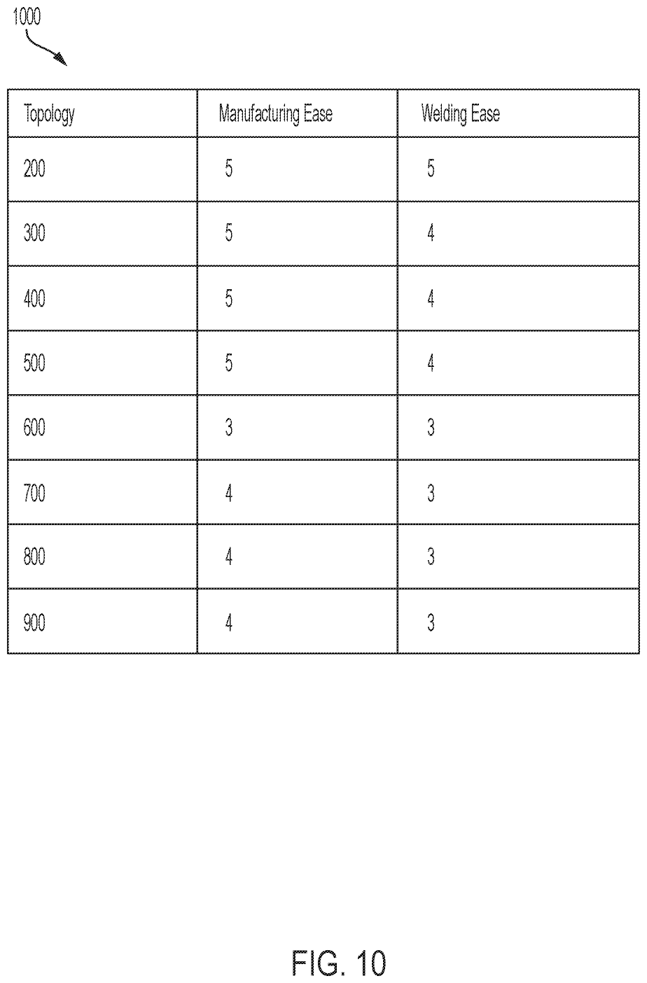

FIG. 10 is a table 1000 comparing topologies 200-900 in terms of ease of manufacture and ease of welding. Ease of welding means the ease with which a cathode relieved weld plate or an anode relieved weld plate may be welded onto a cathode electrode or an anode electrode. Ease of welding is measured in terms of the extent to which a continuous welding operation can be performed on the relieved weld plate without having to stop the welding operation. To illustrate, a welding operation may be considered relatively easy if a laser can continuously weld the relieved weld plate onto the electrode without having to stop. For example, a relatively easy welding process corresponds to few instances of having to stop the welding operation, while a relatively difficult welding process corresponding to more instances of having to stop the welding operation. Ease of welding is rated from 1-5, where 1 corresponds to the most difficult welding process and 5 corresponds to the easiest welding process.

Ease of manufacturing means the ease with which a relieved cathode weld plate or a relieved anode weld plate may be manufactured. For example, ease of manufacturing corresponds to the relative difficulty of stamping out parts of topologies 200-900 with high yield and high quality (i.e., few defects). Thus, a relatively easy manufacturing process corresponds to high yield and high quality parts, while a relatively difficult manufacturing process corresponds to low yield and low quality parts. Ease of manufacture is rated from 1-5, where 1 corresponds to the most difficult manufacturing process and 5 corresponds to the easiest manufacturing process.

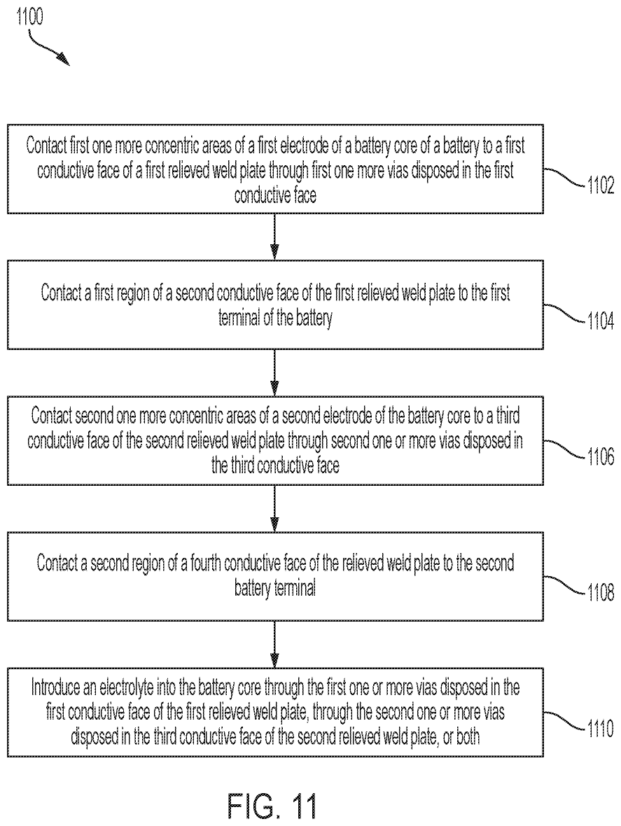

FIG. 11 is a flowchart describing a method 1100 for affixing a relieved weld plate onto one or more concentric spirals (e.g., areas) of an electrode. At block 1102, a first relieved weld plate is affixed to a battery core to provide an electrical connection between the battery core and a first terminal of a battery by contacting first one or more concentric spirals (e.g., areas) of a first electrode of the battery core to a first conductive face of the first relieved weld plate through first one or more pathways disposed in the first conductive face. For example, a conductive face of a cathode relieved weld plate may be welded onto one or more concentric spirals (e.g., areas) of cathode electrode through first one or more pathways disposed in the first conductive face of the anode relieved weld plate. At block 1104, a first region of a second conductive face of the first relieved weld plate is contacted to the first terminal of the battery. For instance, a tab positioned on the second conductive face of the cathode relieved weld plate may be welded onto the a terminal cap of the battery.

At block 1106, a second relieved weld plate is affixed to the battery core to provide an electrical connection between the battery core and a second terminal of the battery by contacting second one or more concentric spirals (e.g., areas) of a second electrode of the battery core to a third conductive face of the second relieved weld plate through second one or more pathways disposed in the third conductive face. For example, a conductive face of an anode relieved weld plate may be welded onto one or more concentric spirals (e.g., areas) of an anode electrode through second one more pathways disposed in the conductive face of the anode relieved weld plate. At block 1108, a second region of a fourth conductive face of the relieved weld plate may be contacted to a second battery terminal. For instance, a weld detent in the anode relieved weld plate may be welded onto the base contact of the battery. At block 1110, electrolyte may be introduced into the battery core through first one or more pathways disposed in the first conductive face of the first relieved weld plate, through second one or more pathways disposed in the third conductive face of the second relieved weld plate, or both.

Disclosed is a means for electrically contacting a battery core to a terminal of a battery. The means for electrically contacting the battery core to the terminal of the battery may correspond to a relieved weld plate, such as the relieved weld plates described in FIGS. 1-9. In embodiments, the relieved weld plate may correspond to a cathode relieved weld plate and/or an anode relieved weld plate. The means for electrically contacting the battery core to the terminal of the battery comprises conductive means for affixing to an electrode of the battery core. The conductive means for affixing to the electrode of the battery core may correspond to a first conductive face, such as first conductive face 204-904. The means for electrically contacting the battery core to the terminal of the battery further comprises opening means for facilitating at least one of ingress of a first material into the battery core or egress of a second material out of the battery core, wherein the opening means are disposed within the conductive means. The opening means may correspond to one or more pathways, such as full pathways and/or interstitial pathways. For instance, the opening means may correspond to any of the interstitial pathways of FIGS. 2-6, to any of the full pathways of FIGS. 7-9, or any combination thereof.

Although the present invention and its advantages have been described in detail, it should be understood that various changes, substitutions and alterations can be made herein without departing from the spirit and scope of the invention as defined by the appended claims. Moreover, the scope of the present application is not indented to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are indented to include within their scope such processes, machines, manufacture, compositions of matter, means, methods, or steps.

Moreover, the scope of the present application is not indented to be limited to the particular embodiments of the process, machine, manufacture, composition of matter, means, methods and steps described in the specification.

What is claimed is:

1. A relieved weld plate for affixing to a battery core to provide an electrical connection between the battery core and a terminal of a battery, the relieved weld plate comprising:
a conductive face configured for affixing to an electrode of the battery core; and
one or more pathways disposed in the conductive face and configured to facilitate at least one of ingress of a first material into the battery core or egress of a second material out of the battery core.

2. The relieved weld plate of claim 1, wherein the electrode of the battery core comprises a cathode electrode of a cathode of the battery core, wherein the relieved weld plate is a cathode relieved weld plate, and wherein the cathode relieved weld plate further comprises a tab configured to electrically connect the cathode relieved weld plate to the terminal of the battery.

3. The relieved weld plate of claim 1, wherein the electrode of the battery core comprises an anode electrode of an anode of the battery core, wherein the relieved weld plate is an anode relieved weld plate, and wherein the anode relieved weld plate further comprises a weld detent configured to electrically connect the anode relieved weld plate to the terminal of the battery.

4. The relieved weld plate of claim 1, wherein the one or more pathways comprise one or more full pathways each formed from a respective relief area disposed radially inboard within the conductive face of the relieved weld plate, and wherein a relief area of each full pathway of the one or more pathways is configured to facilitate contact between the conductive face and inner concentric areas of the electrode.

5. The relieved weld plate of claim 4, wherein the one or more full pathways are disposed within the relieved weld plate to divide the relieved weld plate into halves, thirds, or quarters, and wherein a cumulative relief area of the full pathways is between 40 mm² and 60 mm².

6. The relieved weld plate of claim 1, wherein the one or more pathways comprise one or more interstitial pathways each formed from a relief area disposed within the conductive face of the relieved weld plate and defining interstitial space between a battery housing of the battery and regions of the conductive face of the relieved weld plate, and wherein the relief area of each interstitial pathway of the one or more pathways is configured to facilitate contact between the conductive face and inner concentric areas of the electrode and outer concentric areas of the electrode.

7. The relieved weld plate of claim 6, wherein a cumulative relief area of the one or more interstitial pathways is between 88 mm² and 143 mm².

8. The relieved weld plate of claim 6, wherein the relief areas disposed within the conductive face of the relieved weld plate form a plurality of members within the conductive face.

9. The relieved weld plate of claim 8, wherein a member of the plurality of members extends radially outward from a center of the relieved weld plate.

10. The relieved weld plate of claim 9, wherein a surface area of the member increases as a distance of a radius of the relieved weld plate from a center of the relieved weld plate increases.

11. The relieved weld plate of claim 9, wherein a surface area of the member decreases as a distance of a radius of the relieved weld plate from a center of the relieved weld plate increases.

12. The relieved weld plate of claim 8, wherein a member of the plurality of members is semi-circular.

13. A battery comprising:
a cathode relieved weld plate affixed onto one or more concentric spirals of a cathode electrode of a cathode forming part of a battery core of the battery, wherein the cathode relieved weld plate comprises:
a first conductive face in contact with the one or more concentric spirals of the cathode electrode; and
first one or more pathways configured to permit at least one of ingress of a first material into the battery core of the battery or egress of a second material out of the battery core;
an anode relieved weld plate affixed onto one or more concentric spirals of an anode electrode of an anode forming part of the battery core of the battery, wherein the anode weld plate comprises:
a second conductive face in contact with the one or more spirals of the anode electrode; and
second one or more pathways configured to permit at least one of ingress of the first material into the battery core or egress of the second material out of the battery core.

14. The battery of claim 13, wherein the first one or more pathways are full pathways, wherein the second one or more pathways are interstitial pathways, and wherein the second material corresponds to gases generated through electrolytic chemical reactions in the battery.

15. The battery of claim 14, wherein the cathode relieved weld plate has a first topology, and wherein the anode relieved weld plate has a second topology distinct from the first topology.

16. The battery of claim 15, wherein the first topology corresponds to a cylinder having two, three, or four full pathways disposed radially inboard within the first conductive face, and wherein the second topology corresponds to a cylinder having four pathways of approximately equal area demarcating the battery core into quarters.

17. A method comprising:
affixing a first relieved weld plate to a battery core to provide a first electrical connection between the battery core and a first terminal of a battery by contacting first one or more concentric areas of a first electrode of the battery core to a first conductive face of the first relieved weld plate through first one or more pathways disposed in the first conductive face;
contacting a first region of a second conductive face of the first relieved weld plate to the first terminal of the battery; and
introducing electrolyte into the battery core through the first one or more pathways disposed in the first conductive face.

18. The method of claim 17, the method further comprising:
affixing a second relieved weld plate to the battery core to provide a second electrical connection between the battery core and a second terminal of the battery by contacting second one or more concentric areas of a second electrode of the battery core to a third conductive face of the second relieved weld plate through second one more pathways disposed in the third conductive face; and
contacting a second region of a fourth conductive face of the relieved weld plate to the second terminal of the battery.

19. The method of claim 18, wherein the first region of the second conductive face corresponds to a tab configured to be welded onto the first terminal of the battery, and wherein the second region of the fourth conductive face corresponds to a weld detent configured to be welded onto the second terminal of the battery.

20. The method of claim 18, wherein the first one or more pathways correspond to full pathways or interstitial pathways, and wherein the second one or more pathways correspond to full pathways or interstitial pathways.
